(19) United States
(12) Patent Application Publication
(10) Pub. No.: US 2014/0159691 A1
(43) Pub. Date: Jun. 12, 2014

(54) SWITCHING POWER SOURCE DEVICE

(71) Applicant: Rohm Co., Ltd., Kyoto (JP)

(72) Inventor: Yoshinori Miyamae, Kyoto (JP)

(73) Assignee: Rohm Co., Ltd., Kyoto (JP)

(21) Appl. No.: 14/103,096

(22) Filed: Dec. 11, 2013

(30) Foreign Application Priority Data
Dec. 12, 2012 (JP) 2012270990

(51) Int. Cl. H02M 3/158

(52) U.S. Cl. CPC H02M 3/1588
USPC 323/283

(57) ABSTRACT

A switching power source device according to the present invention has a control portion that performs, at predetermined cycles, PWM pulse width modulation) driving with respect to an output transistor and a synchronous rectification transistor so that a desired output voltage is generated from an input voltage and a rectification method changeover portion that performs changeover of a rectification method so that, in one cycle, a synchronous rectification operation and a diode rectification operation are performed in a time-shared manner.

### CROSS-REFERENCE TO RELATED APPLICATIONS

This application is based on and claims the benefit of priority from the following Japanese Patent Application, the contents of which are hereby incorporated by reference.

(1) Japanese Patent Application No. 2012-270990 (filing date: Dec. 12, 2012)

### BACKGROUND OF THE INVENTION

1. Field of the Invention

The present invention relates to a switching power source device based on a synchronous rectification method.

2. Description of Related Art

Conventionally, there has been widely used a switching power source device based on the synchronous rectification method as a power source for a wide variety of electronic apparatuses (see, for example, JP-A-2009-165236).

By the way, in a switching power source device of a positive voltage step-up type adopting the synchronous rectification method, when an input voltage IN and an output voltage OUT come to a state of being substantially equal to each other, an on-duty D (=(OUT−IN)/OUT) of an output transistor becomes extremely small to cause system instability.

As a technique for solving the above-described problem, typically, pulse skip control (control in which an output transistor and a synchronous rectification transistor are deliberately stopped from being driven over one cycle or a plurality of cycles) is performed. The pulse skip control, however, has been problematic in that it requires a complicated control circuit and causes an increase in ripple component of an output voltage.

On the other hand, in a case of adopting a diode rectification method instead of the synchronous rectification method, an on-duty D (=(OUT+Vf−IN)/(OUT+Vf), where Vf is a forward drop voltage of a diode) becomes relatively long, and thus system stability is easily established. The diode rectification method, however, has been problematic in that a resulting power loss due to a voltage drop in a diode is large as compared with that in a case of the synchronous rectification method, which results in a decrease in efficiency.

The above-described problems could occur not only in a switching power source device of the positive voltage step-up type but also in switching power source devices of a voltage step-down type and an inverse type (negative voltage step-up type).

### SUMMARY OF THE INVENTION

In view of the above-described problems found by the inventor of the present application, the present invention has as its object to provide a switching power source device capable of achieving high efficiency while maintaining system stability.

In order to achieve the above-described object, a switching power source device according to the present invention has a configuration including a control portion that performs, at predetermined cycles, PWM pulse width modulation) driving with respect to an output transistor and a synchronous rectification transistor so that a desired output voltage is generated from an input voltage and a rectification method changeover portion that performs changeover of a rectification method so that, in one cycle, a synchronous rectification operation and a diode rectification operation are performed in a time-shared manner.

Other features, constituent components, operational steps, advantages, and characteristics of the present invention will be further clarified by the following detailed descriptions of best modes and appended drawings related thereto.

### BRIEF DESCRIPTION OF THE DRAWINGS

FIG. 1 is a block diagram showing a first embodiment of a switching power source device.

FIG. 2 is a timing chart showing a first example of a switching operation.

FIG. 3 is a timing chart showing a second example of the switching operation.

FIG. 4 is a timing chart showing a third example of the switching operation.

FIG. 5 is a timing chart showing a fourth example of the switching operation.

FIG. 6 is a timing chart showing a fifth example of the switching operation.

FIG. 7 is a block diagram showing a second embodiment of the switching power source device.

FIG. 8 is a block diagram showing a third embodiment of the switching power source device.

FIG. 9 is an appearance view showing one example of an electronic apparatus incorporating the switching power source device.

FIG. 10 is a block diagram showing a first modification example of the switching power source device.

FIG. 11 is a block diagram showing a second modification example of the switching power source device.

### DETAILED DESCRIPTION OF PREFERRED EMBODIMENTS

### First Embodiment

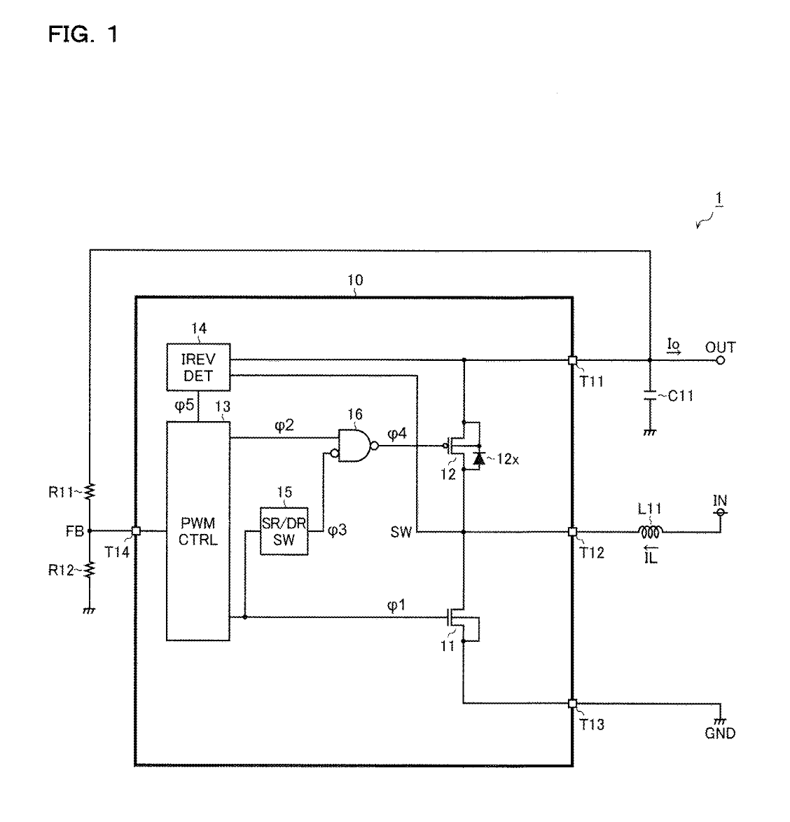

FIG. 1 is a block diagram showing a first embodiment of a switching power source device. A switching power source device 1 of the first embodiment is a switching power source device of the positive voltage step-up type based on the synchronous rectification method, which boosts an input voltage IN to generate a desired output voltage OUT and supplies the output voltage OUT to an unshown load (for example, a liquid crystal display panel). The switching power source device 1 has a semiconductor device 10 and various discrete components (an inductor L11, a capacitor C11, and resistors R11 and R12) externally connected to the semiconductor device 10.

The semiconductor device 10 has external terminals T11 to T14 for establishing an electrical connection with the outside. Outside the semiconductor device 10, the external terminal T11 (output terminal) is connected to an application end of the output voltage OUT and to each of a first end of the capacitor C11 and a first end of the resistor R11. A second end of the capacitor C11 is connected to a ground end. A second end of the resistor R11 and a first end of the resistor R12 are connected to the external terminal T14 (feedback terminal). A second end of the resistor R12 is connected to the ground end. The resistors R11 and R12 function as a feedback voltage generation portion that outputs, from a connection node between them, a feedback voltage FB obtained by dividing the output voltage OUT. The external terminal T12 (switch terminal) is connected to a first end of the inductor L11. A second end of the inductor L11 is connected to an application end of the input voltage IN. At the external terminal T12, a switch voltage SW having a rectangular waveform appears in accordance with the on/off of an output transistor 11 and a synchronous rectification transistor 12, which are to be described later. The external terminal T13 (ground terminal) is connected to the ground end.

The semiconductor device 10 is a monolithic semiconductor integrated circuit device (so-called switching power source IC) in which the output transistor 11, the synchronous rectification transistor 12, a control portion 13, a countercurrent detection portion 14, a rectification method changeover portion 15, and a logic gate 16 are integrated.

The output transistor 11 is a switch element (N-channel type MOS field-effect transistor) that is connected between the external terminal T12 and the external terminal T13 and is turned on/off in accordance with a drive signal φ1 inputted from the control portion 13. To be specific in terms of connection relationships, a drain of the output transistor 11 is connected to the external terminal T12. A source and a back gate of the output transistor 11 are both connected to the output terminal T13. A gate of the output transistor 11 is connected to an application end of the drive signal φ1.

The synchronous rectification transistor 12 is a switch element (P-channel type MOS field-effect transistor) that is connected between the external terminal T11 and the external terminal T12 and is turned on/off in accordance with a drive signal φ4 inputted from the logic gate 16. To be specific in terms of connection relationships, a drain of the synchronous rectification transistor 12 is connected to the external terminal T12. A source and a back gate of the synchronous rectification transistor 12 are both connected to the external terminal T11. A gate of the synchronous rectification transistor 12 is connected to an application end of the drive signal φ4. The synchronous rectification transistor 12 is accompanied by a body diode 12x whose anode is connected to the drain thereof and whose cathode is connected to the back gate thereof.

The control portion 13 generates, in accordance with the feedback voltage FB, the drive signals φ1 and φ2 and uses them to perform complementary (exclusive) on/off control (PWM driving) with respect to the output transistor 11 and the synchronous rectification transistor 12 to thereby generate a desired output voltage OUT from the input voltage IN. The term “complementary (exclusive)” used in this specification is intended to refer not only to a case where on/off states of the output transistor 11 and the synchronous rectification transistor 12 are completely contrary to each other but also to a case where, from a standpoint of preventing a flow-through current, a predetermined delay is given to on/off transition timings of the output transistor 11 and the synchronous rectification transistor 12 (a case where a simultaneous off period is provided).

As for output feedback control by the control portion 13, performing the control only requires known techniques to be applied thereto, and a detailed description thereof, therefore, is omitted herein. The output feedback control could be performed by using, for example, a configuration in which an error voltage corresponding to a difference between a feedback voltage and a reference voltage is generated, and with reference to a PWM signal generated based on a result of a comparison between the error voltage and a slope voltage, the drive signals φ1 and φ2 are generated.

Furthermore, the control portion 13 is provided with a function (switching stop function) of forcibly turning off the synchronous rectification transistor 12 at a point in time when a countercurrent detection signal φ5 becomes high in level (a point in time when a countercurrent flowing to the synchronous rectification transistor 12 is detected). This function makes it possible to block a countercurrent flowing to the synchronous rectification transistor 12 and thus to improve efficiency at the time of a light load.

The countercurrent detection portion 14 compares the switch voltage SW with the output voltage OUT in an on period of the synchronous rectification transistor 12 to thereby detect a countercurrent flowing to the synchronous rectification transistor 12 (a current flowing backward from the external terminal T11 toward the external terminal T12) and, upon the detection, generates the countercurrent detection signal φ5. The countercurrent detection signal φ5 becomes low in level when the switch voltage SW is higher than the output voltage OUT and becomes high in level when the switch voltage SW is lower than the output voltage OUT. That is, the countercurrent detection signal φ5 becomes low in level when an inductor current IL is flowing from the application end of the input voltage IN toward the application end of the output voltage OUT via the synchronous rectification transistor 12 and becomes high in level when the inductor current IL flows backward from the application end of the output voltage OUT toward the application end of the input voltage IN via the synchronous rectification transistor 12.

The rectification method changeover portion 15 performs, in one cycle of PWM driving, a synchronous rectification operation (SR [synchronous rectification]) contributing to enhancing efficiency and a diode rectification operation (DR [diode rectification]) contributing to establishing system stability in a time-shared manner, and generates a changeover signal φ3 for performing changeover of a rectification method for the switching power source device 1 so as to be able to achieve high efficiency while maintaining system stability. The changeover signal φ3 becomes low in level at the time of the synchronous rectification operation and becomes high in level at the time of the diode rectification operation. A rectification method changeover operation is to be described in detail later.

The logic gate 16 (NAND gate) logically synthesizes the drive signal φ2 inputted to a first input end thereof with the changeover signal φ3 inversely inputted to a second input end thereof to thereby generate the drive signal φ4. In a case where the changeover signal 93 is at a low level, the drive signal φ4 turns out to be a signal having a logic level inverse to that of the drive signal φ2. On the other hand, in a case where the changeover signal φ3 is at a high level, the drive signal φ4 is always at a high level irrespective of a logic level of the drive signal φ2.

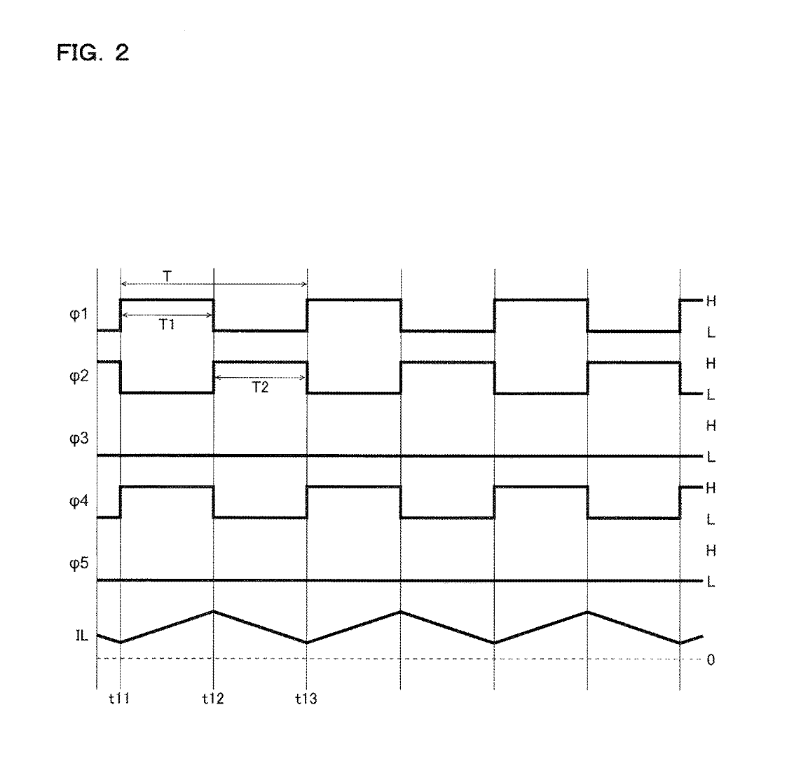

FIG. 2 is a timing chart showing a first example (IN<<OUT; continuous current mode) of a switching operation, in which, in order from the top, behaviors of the drive signal φ1, the drive signal φ2, the changeover signal φ3, the drive signal φ4, the countercurrent detection signal φ5, and the inductor current IL are depicted.

In a case where the output voltage OUT is sufficiently higher than the input voltage IN, an on-duty D of the output transistor 11 (a ratio of a high level period T1 of the drive signal φ1 (=an on period T1 of the output transistor 11) to a cycle T of PWM driving) does not become so small, and thus even in the synchronous rectification operation, system instability is unlikely to occur. For this reason, in the case where the output voltage OUT is sufficiently higher than the input voltage IN, preferably, in one cycle of PWM driving, instead of performing changeover from the synchronous rectification operation to the diode rectification operation, only the synchronous rectification operation is continuously performed.

To this end, the rectification method changeover portion 15 monitors the drive signal φ1, and when the high level period T1 thereof is longer than a predetermined value, it judges that the output voltage OUT is sufficiently higher than the input voltage IN and, based on this judgment, maintains the changeover signal φ3 at a low level in a high level period T2 of the drive signal φ2 (=an on period T2 of the synchronous rectification transistor 12). As a result, the drive signal φ4 turns out to be a signal having a logic level inverse to that of the drive signal φ2, and thus the synchronous rectification transistor 12 is kept turned on over the high level period T2 of the drive signal φ2, so that in one cycle of PWM driving, only the synchronous rectification operation is performed.

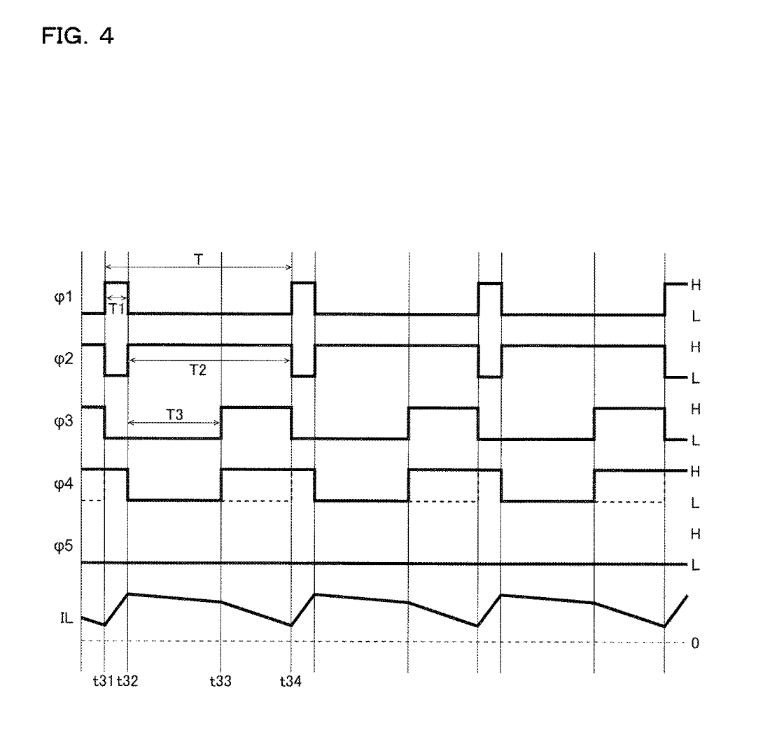

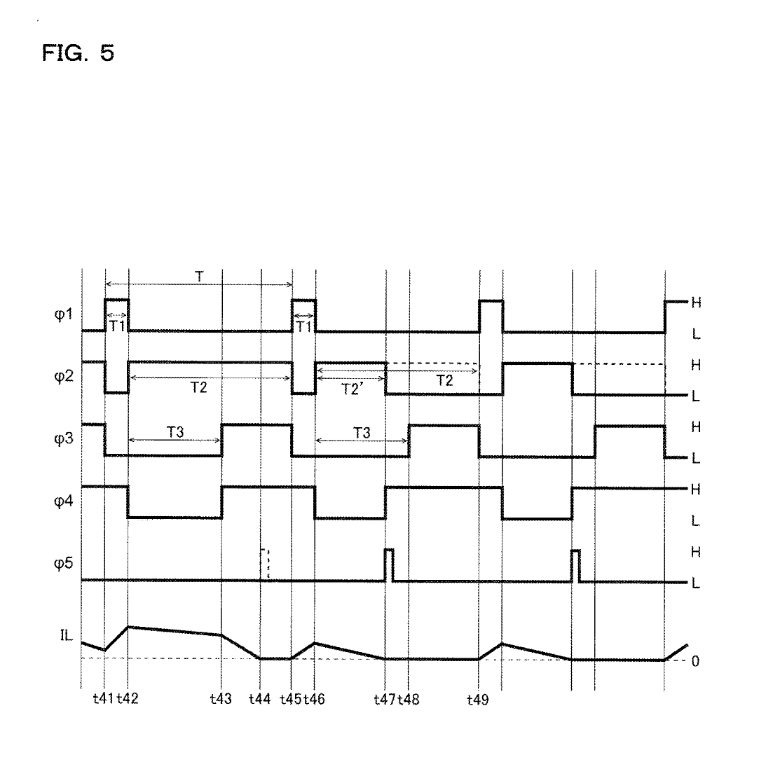

On the other hand, when the high level period T1 of the drive signal φ1 is shorter than the predetermined value, the rectification method changeover portion 15 makes the changeover signal φ3 rise to a high level in at least a part of the high level period T2 of the drive signal φ2 to perform changeover from the synchronous rectification operation to the diode rectification operation. This is to be detailed later by referring to FIGS. 4 and 5.

As described above, the rectification method changeover portion 15 monitors the high level period T1 of the drive signal φ1 and performs, based on a result of the monitoring, changeover between whether, in one cycle, to perform only the synchronous rectification operation or to perform the synchronous rectification operation and the diode rectification operation in a time-shared manner. With this configuration, in a case where the output voltage OUT is sufficiently higher than the input voltage IN and thus there is no need for concern about causing system instability, it becomes possible to achieve high efficiency on a priority basis by performing only the synchronous rectification operation.

As for a timing at which a result of monitoring the high level period T1 is reflected in an operation of generating the changeover signal φ3, such a monitoring result obtained in a current cycle may be reflected in the operation performed in the same cycle or in a succeeding cycle.

Furthermore, a judgment criterion, based on which changeover is performed between whether, in one cycle, to perform only the synchronous rectification operation or to perform the synchronous rectification operation and the diode rectification operation in a time-shared manner, is not limited to a result of monitoring the high level period T1, and as such a judgment criterion, a result of a comparison between the input voltage IN and the output voltage OUT, an external control signal from a host (such as a microcomputer), or set data stored in a register (not shown), or the like also can be used.

Furthermore, in a low level period of the drive signal φ2, the changeover signal φ3 can have any logic level. In order, however, to avoid a possibility that an unintended diode rectification operation is performed immediately after the drive signal φ2 has risen from a low level to a high level, preferably, in a low level period of the drive signal φ2, the changeover signal φ3 is maintained at a low level.

The following specifically describes the switching operation by using an example shown in FIG. 2. At times t11 through t12, the drive signal φ1 is at a high level, and thus the output transistor 11 is turned on. Furthermore, at times t11 through t12, the drive signals φ2 and φ3 are both at a low level, so that the drive signal φ4 becomes high in level, and thus the synchronous rectification transistor 12 is turned off. At this time, the inductor current IL directed toward the ground end via the output transistor 11 flows through the inductor L11, and electric energy thereof is stored in the inductor L11.

In a case where, at times t11 through t12, electric charge has already been accumulated in the capacitor C11, an output current Io flows from the capacitor C11 through a load. At this time, since the synchronous rectification transistor 12 is off, in no case does the output current Io flow backward from the capacitor C11 toward the output transistor 11.

On the other hand, at times t12 through t13, the drive signal φ1 is at a low level, and thus the output transistor 11 is turned off. Furthermore, at times t12 through t13, the drive signal φ2 is at a high level and the drive signal φ3 is at a low level, so that the drive signal φ4 becomes low in level, and thus the synchronous rectification transistor 12 is turned on. At this time, the inductor L11 releases the electric energy stored in itself and continues to cause the inductor current IL to flow in the same direction as before. The inductor current IL flowing via the synchronous rectification transistor 12 flows as the output current Io into the load, and flows also into the ground end via the capacitor C11, thus charging the capacitor C11.

Upon, at time t12, the inductor Lit being changed over in its state from charging to discharging, the inductor current IL, which has increased, turns to decrease. When, however, the output current Io flowing through the load is sufficiently large, until time t13 at which the drive signal φ1 is made to rise again to a high level, the inductor current IL continues to flow toward the load without falling below a zero value. Hence, there occurs no countercurrent flowing to the synchronous rectification transistor 12, and thus the countercurrent detection signal φ5 is maintained at a low level.

The above-described operation is repeatedly performed, as a result of which the output voltage OUT as smoothed out by the capacitor C11 is supplied to the load.

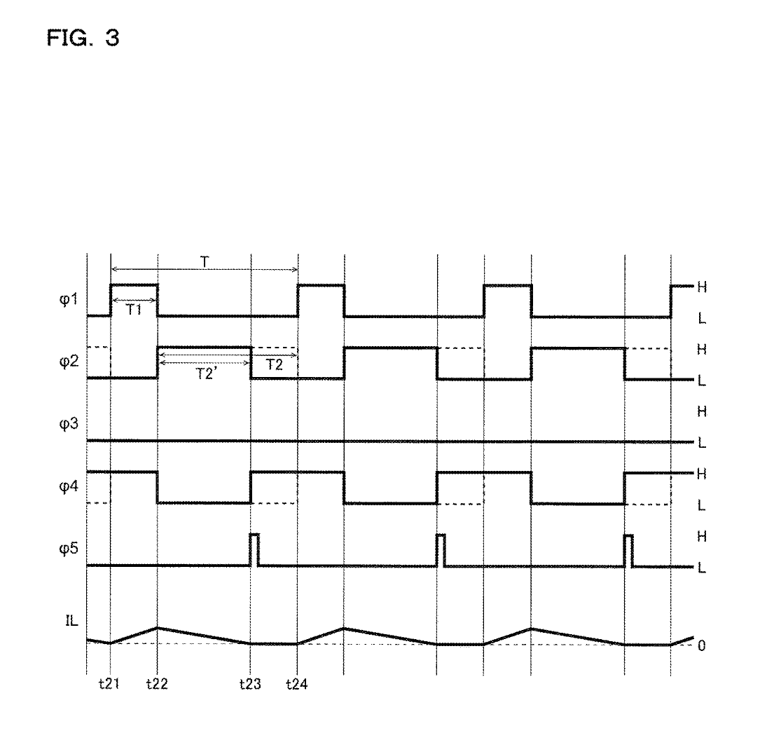

FIG. 3 is a timing chart showing a second example (IN<<OUT; discontinuous current mode) of the switching operation, in which, in order from the top, behaviors of the drive signal φ1, the drive signal φ2, the changeover signal φ3, the drive signal φ4, the countercurrent detection signal φ5, and the inductor current IL are depicted.

Similarly to FIG. 2, FIG. 3 exemplarily shows a case where the output voltage OUT is sufficiently higher than the input voltage IN and, in one cycle of PWM driving, only the synchronous rectification operation is performed.

After a lapse of an on period (t21 through t22) of the output transistor 11, at time t22, the drive signal φ1 is made to fall to a low level and the drive signal φ2 is made to rise to a high level, so that the output transistor 11 is turned off and the synchronous rectification transistor 12 is turned on. Consequently, the inductor current IL, which has increased, turns to decrease.

Herein, when the output current Io flowing through the load is sufficiently large, until time t24 at which the drive signal φ1 is made to rise again to a high level, the inductor current IL continues to flow toward the load without falling below a zero value. On the other hand, at the time of a light load when the output current Io flowing through the load is small, the amount of energy stored in the inductor L11 is small, and thus at time t23, the inductor current IL falls below a zero value, so that there occurs a countercurrent flowing to the synchronous rectification transistor 12. This, in fact, is a state where electric charge is being fed back to the application end of the input voltage IN, which leads to a decrease in efficiency at the time of a light load.

As a solution to this, the switching power source device 1 has a configuration in which a countercurrent flowing to the synchronous rectification transistor 12 is detected by using the countercurrent detection portion 14, and at time t23 at which the countercurrent detection signal φ5 rises to a high level, the synchronous rectification transistor 12 is forcibly turned off to shorten an on period thereof from T2 to T2′. With this configuration, it becomes possible to prevent a decrease in efficiency at the time of a light load.

FIG. 4 is a timing chart showing a third example (IN≈OUT; continuous current mode) of the switching operation, in which, in order from the top, behaviors of the drive signal φ1, the drive signal φ2, the changeover signal φ3, the drive signal φ4, the countercurrent detection signal φ5, and the inductor current IL are depicted.

When the synchronous rectification operation is performed in a state where the output voltage OUT is approximate to the input voltage IN (or a state where these voltages are substantially equal to each other), the on-duty D of the output transistor 11 becomes extremely small, which might cause system instability. For this reason, in a case where the output voltage OUT is approximate to the input voltage IN, preferably, in one cycle of PWM driving, instead of performing only the synchronous rectification operation, changeover from the synchronous rectification operation to the diode rectification operation is performed.

To this end, the rectification method changeover portion 15 monitors the drive signal φ1, and when the high level period T1 thereof is shorter than a predetermined value, it judges that the output voltage OUT is approximate to the input voltage IN, and, based on this judgment, forcibly turns off the synchronous rectification transistor 12 in at least a part of the high level period T2 of the drive signal φ2 (=an on period of the synchronous rectification transistor 12) to thereby perform changeover from the synchronous rectification operation to the diode rectification operation.

To be more specific, at a point in time when a predetermined synchronous rectification period T3 has elapsed after the drive signal φ2 had been made to rise to a high level, the rectification method changeover portion 15 makes the changeover signal φ3 rise to a high level, and then, at a point in time when the drive signal φ2 is made to fall to a low level, makes the changeover signal φ3 fall to a low level.

As a result, during a time when the changeover signal φ3 is at a high level, the drive signal φ4 becomes high in level irrespective of a logic level of the drive signal φ2, and thus the synchronous rectification transistor 12 is forcibly turned off. At this time, the inductor current IL, which was flowing through the synchronous rectification transistor 12 until that time, continues to flow via the body diode 12x. Consequently, in one cycle of PWM driving, changeover from the synchronous rectification operation to the diode rectification operation is performed.

With this configuration in which changeover between the synchronous rectification operation and the diode rectification operation is performed in a time-shared manner, even in the case where the output voltage OUT is approximate to the input voltage IN, the on-duty D does not become extremely small, and thus it becomes possible to maintain system stability.

Furthermore, with the configuration in which changeover between the synchronous rectification operation and the diode rectification operation is performed in a time-shared manner, as compared with a configuration in which only the diode rectification operation is performed, it becomes possible to suppress a power loss. The inductor current IL reaches its peak immediately before the output transistor 11 is turned off, and after the output transistor 11 has been turned off, it gradually decreases with a lapse of time. With this in view, preferably, in a first half of the high level period T2 of the drive signal φ2, in which a large inductor current IL flows, the synchronous rectification operation is performed by using the synchronous rectification transistor 12 whose drop voltage is small, and in a latter half of the high level period T2 of the drive signal φ2, in which the inductor current IL decreases, the diode rectification operation contributing to establishing system stability is performed.

Furthermore, with the configuration in which changeover between the synchronous rectification operation and the diode rectification operation is performed in a time-shared manner, compared with a case where pulse skip control is performed, there is also provided an advantage that a simplified control circuit is used and a ripple component of the output voltage OUT is suppressed to be small.

A length of the synchronous rectification period T3 (a low level period of the drive signal φ3) could be set as appropriate in consideration of a minimum pulse width of the drive signal φ1. The shorter the synchronous rectification period T3 is set to be, the longer a diode rectification period (=T2−T3) becomes, in which case while the high level period T1 of the drive signal φ1 is lengthened to allow a margin in terms of circuit capabilities of the control portion 13, a power loss at the body diode 12x is increased. On the other hand, the longer the synchronous rectification period T3 is set to be, the shorter the diode rectification period (=T2−T3) becomes, in which case while a power loss at the body diode 12x is reduced, the high level period T1 of the drive signal φ1 is shortened to no longer allow a margin in terms of circuit capabilities of the control portion 13.

As a solution to this, the rectification method changeover portion 15 is provided with a function of monitoring the drive signal φ1 and adjusting a length of the synchronous rectification period T3 (and therefore a timing for performing changeover of a rectification method) in accordance with the high level period T1 of the drive signal φ1. With this configuration, it becomes possible to set a length of the synchronous rectification period T3 (conversely, a length of a diode rectification period) in an appropriate manner, i.e. so that the high level period T1 (pulse width) of the drive signal φ1 is not shorter than a minimum pulse width thereof.

One possible example of a technique for calculating the synchronous rectification period T3 is as follows. That is, based on the high level period T1 of the drive signal φ1, the high level period T2 (=T−T1) of the drive signal φ2 is determined, which then is multiplied by a preset rate α (where 0<α<1), and this is how the synchronous rectification period T3 (=α×T2) is calculated. The rate α described above may be a preset fixed value or a variable value arbitrarily adjustable by a user.

A configuration may be adopted in which the high level period T2 of the drive signal φ2 is directly monitored. In this case, however, a monitoring result obtained in a previous cycle is reflected in calculation processing performed in a succeeding cycle.

The following specifically describes the switching operation by using an example shown in FIG. 4. At times t31 through t32, the drive signal φ1 is at a high level, and thus the output transistor 11 is turned on. Furthermore, at times t31 through t32, the drive signals φ2 and φ3 are both at a low level, so that the drive signal φ4 becomes high in level, and thus the synchronous rectification transistor 12 is turned off. At this time, the inductor current IL directed toward the ground end via the output transistor 11 flows through the inductor L11, and electric energy thereof is stored in the inductor L11.

At times t32 through t33, the drive signal φ1 is at a low level, and thus the output transistor 11 is turned off. Furthermore, at times t32 through t33, the drive signal φ2 is at a high level and the drive signal φ3 is at a low level, so that the drive signal φ4 becomes low in level, and thus the synchronous rectification transistor 12 is turned on. At this time, the inductor L11 releases the electric energy stored in itself and continues to cause the inductor current IL to flow in the same direction as before. The inductor current IL flowing via the synchronous rectification transistor 12 flows as the output current Io into the load, and flows also into the ground end via the capacitor C11, thus charging the capacitor C11. That is, times t32 through t33 correspond to a synchronous rectification period.

At times t33 through t34, the drive signal φ1 is maintained at a low level, and thus the output transistor 11 remains turned off. Furthermore, at times t33 through t34, the drive signal φ2 is maintained at a high level while the drive signal φ3 is at a high level, so that the drive signal φ4 becomes high in level, and thus the synchronous rectification transistor 12 is turned off. At this time, the inductor current IL continues to flow to the load and to the capacitor C11 via the body diode 12x. That is, times t33 through t34 correspond to a diode rectification period.

Upon, at time t32, the inductor L11 being changed over in its state from charging to discharging, the inductor current IL, which has increased, turns to decrease, and upon changeover from the synchronous rectification operation to the diode rectification operation at time t33, the inductor current IL decreases at an increased rate. When, however, the output current Io flowing through the load is sufficiently large, until time t34 at which the drive signal φ1 is made to rise again to a high level, the inductor current IL continues to flow toward the load without falling below a zero value. Hence, there occurs no countercurrent flowing to the synchronous rectification transistor 12, and thus the countercurrent detection signal φ5 is maintained at a low level.

The above-described operation is repeatedly performed, as a result of which the output voltage OUT as smoothed out by the capacitor C11 is supplied to the load.

FIG. 5 is a timing chart showing a fourth example (IN≈OUT; discontinuous current mode) of the switching operation, in which, in order from the top, behaviors of the drive signal φ1, the drive signal φ2, the changeover signal φ3, the drive signal φ4, the countercurrent detection signal φ5, and the inductor current IL are depicted.

Similarly to FIG. 4, FIG. 5 exemplarily shows a case where the output voltage OUT is approximate to the input voltage IN and, in one cycle of PWM driving, changeover between the synchronous rectification operation and the diode rectification operation is performed.

In a first cycle (times t41 through t45), after a lapse of an on period (times t41 through t42) of the output transistor 11, at times t42 through t43, the synchronous rectification operation is performed, and at times t43 through t45, the diode rectification operation is performed. In the first cycle, at time t44 at which the diode rectification operation is going on, the inductor current IL decreases to a zero value; at this point in time, however, the synchronous rectification transistor 12 has already been turned off. Hence, no countercurrent flows to the synchronous rectification transistor 12, and thus the countercurrent detection signal φ5 remains at a low level.

Also in a second cycle (times t45 through t49), after a lapse of an on period (times t45 through t46) of the output transistor 11, the synchronous rectification operation is started from time t46. In the second cycle, however, before the synchronous rectification period T3 (times t45 through t48) elapses, at time t47 at which the synchronous rectification operation is going on, the inductor current IL falls below a zero value, so that there occurs a countercurrent flowing to the synchronous rectification transistor 12. As a result, at time t47 at which the countercurrent detection signal φ5 rises to a high level, the synchronous rectification transistor 12 is forcibly turned off, and thus an on period thereof is shortened from T2 to T2′, so that the diode rectification operation is not carried out.

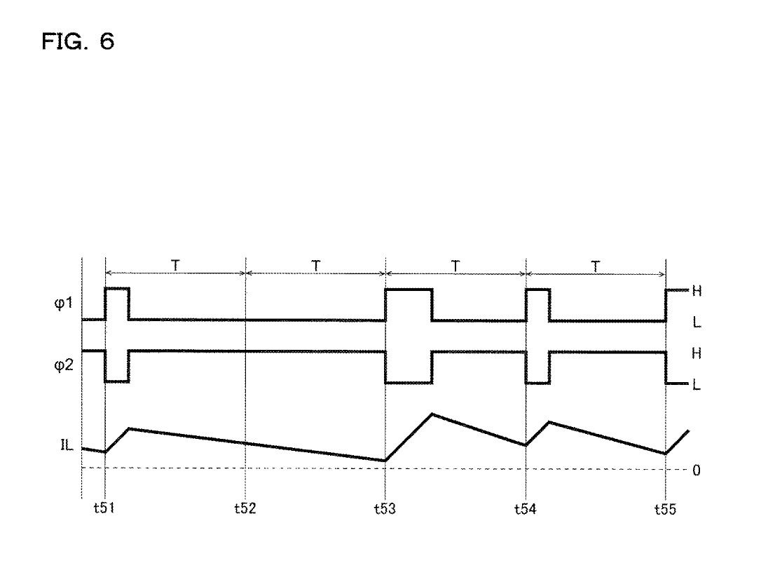

FIG. 6 is a timing chart showing a fifth example pulse skip control) of the switching operation, in which, in order from the top, behaviors of the drive signal φ1, the drive signal φ2, and the inductor current IL are depicted.

As shown in this figure, the control portion 13 is provided with a function of performing pulse skip control in which the output transistor 11 and the synchronous rectification transistor 12 are deliberately stopped from being driven over one cycle or a plurality of cycles (one cycle from time t52 through time t53 in an example shown in FIG. 6). The pulse skip control is carried out herein not for the purpose of establishing system stability when the output voltage OUT becomes approximate to the input voltage IN but for the purpose of reducing self power consumption in a situation where there is no need to perform switching over one cycle or a plurality of cycles, such as at the time of a super-light load or at the time of no load.

### Second Embodiment

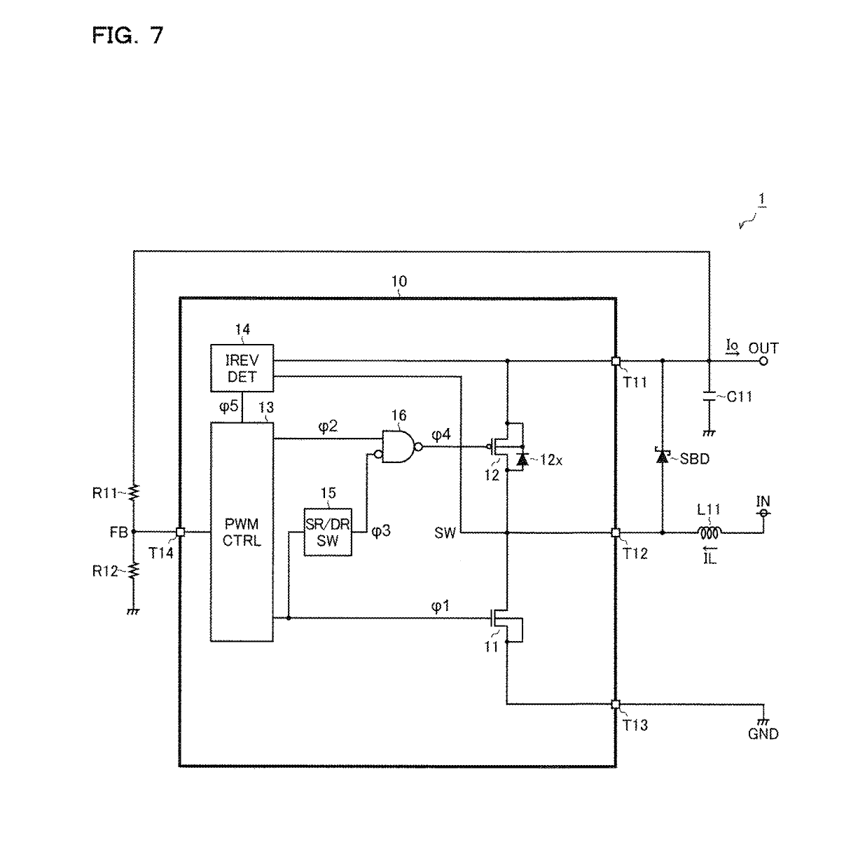

FIG. 7 is a block diagram showing a second embodiment of the switching power source device. The second embodiment is fundamentally similar in configuration to the first embodiment and is characterized in that a Schottky barrier diode SBD is externally connected between the external terminals T11 and T12. Constituent components similar to those in the first embodiment, therefore, are denoted by the same reference characters as in FIG. 1, with duplicate descriptions thereof omitted, and the following focuses on characteristic features of the second embodiment.

As described above, in a switching power source device 1 of the second embodiment, the Schottky barrier diode SBD is connected in parallel with a synchronous rectification transistor 12. While a body diode 12x has a forward drop voltage of 0.6 V to 0.7 V, the Schottky barrier diode SBD has a fairly low forward drop voltage of 0.1 V to 0.2 V. Consequently, compared with the first embodiment in which the diode rectification operation using the body diode 12x alone is performed, it becomes possible to improve efficiency at the time of the diode rectification operation.

### Third Embodiment

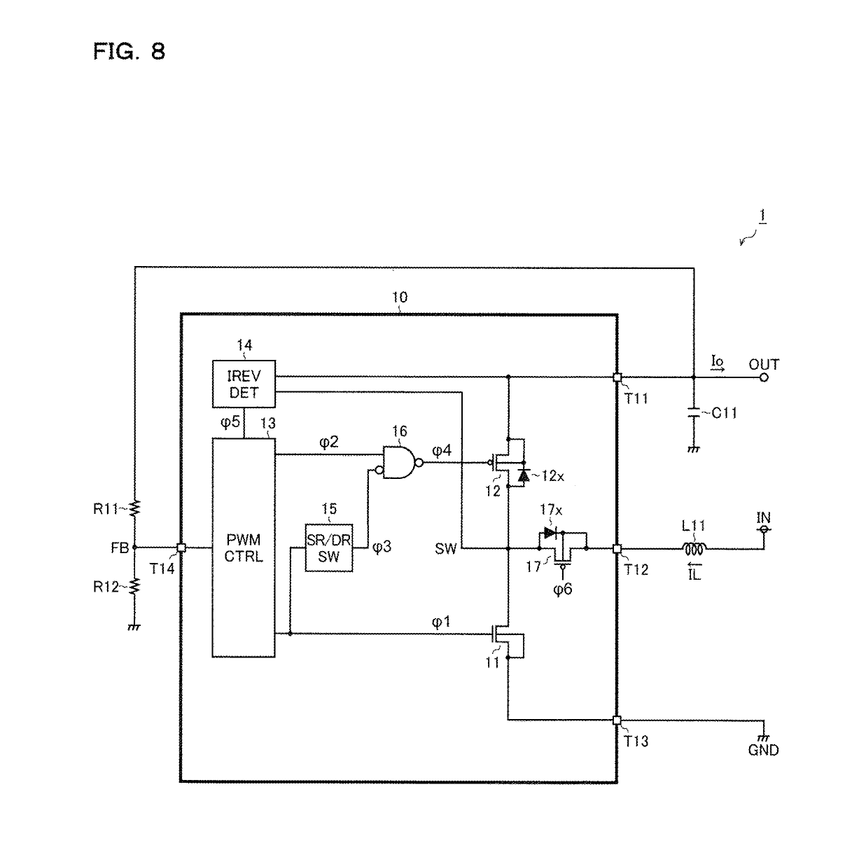

FIG. 8 is a block diagram showing a third embodiment of the switching power source device. The third embodiment is fundamentally similar in configuration to the first embodiment and is characterized in that an input blocking transistor 17 that connects/disconnects a supply path of an input voltage IN is provided. Constituent components similar to those in the first embodiment, therefore, are denoted by the same reference characters as in FIG. 1, with duplicate descriptions thereof omitted, and the following focuses on characteristic features of the third embodiment.

The input blocking transistor 17 is a switch element (P-channel type MOS field-effect transistor) having a polarity opposite to that of a synchronous rectification transistor 12, which is inserted between an external terminal T11 and an external terminal T12 and turned on/off in accordance with a standby signal φ6. To be specific in terms of connection relationships regarding the input blocking transistor 17, a drain of the input blocking transistor 17 is connected to a drain of the synchronous rectification transistor 12. A source and a back gate of the input blocking transistor 17 are both connected to the external terminal T12. A gate of the input blocking transistor 17 is connected to an application end of the standby signal φ6. The input blocking transistor 17 is accompanied by a body diode 17x whose anode is connected to the drain thereof and whose cathode is connected to the back gate thereof.

When a switching power source device 1 is on standby (a state where, while the input voltage IN is being applied, the generation of an output voltage OUT should be stopped), the standby signal φ6 is at a high level, and thus the input blocking transistor 17 is turned off. Accordingly, a current path leading from an application end of the input voltage IN to an application end of the output voltage OUT via a body diode 12x of the synchronous rectification transistor 12 is disconnected, and thus it becomes possible to reduce the output voltage OUT down to 0 V at the time of standby.

On the other hand, when the switching power source device 1 is active (a state where the output voltage OUT should be generated), the standby signal φ6 is at a low level, and thus the input blocking transistor 17 is turned on. Accordingly, the supply path of the input voltage IN is connected, and thus in no case is an operation of generating the output voltage OUT disrupted.

<Application of the Present Invention to Electronic Apparatuses>

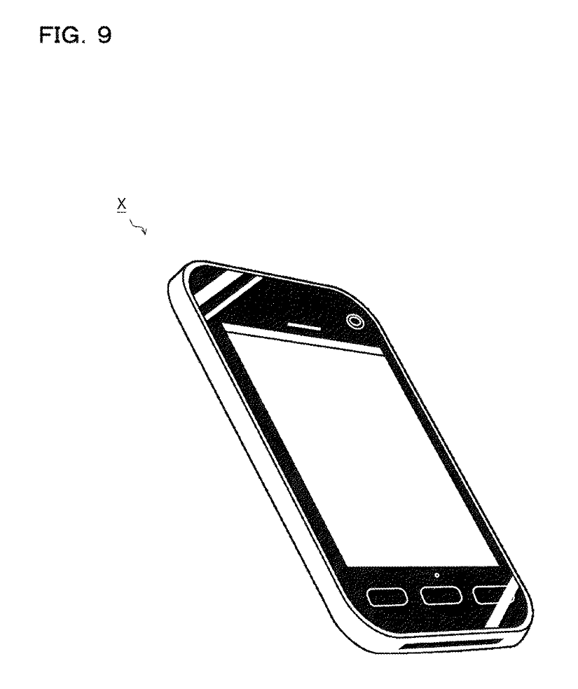

FIG. 9 is an appearance view showing one example φortable terminal (smartphone) X) of an electronic apparatus incorporating the switching power source device 1. The portable terminal X, however, is shown by way of example only of an electronic apparatus in which the switching power source device 1 is favorably mounted, and the foregoing switching power source device 1 can be mounted in a wide variety of electronic apparatuses φarticularly, electronic apparatuses in which there occurs large variations in input and load).

### Other Modification Examples

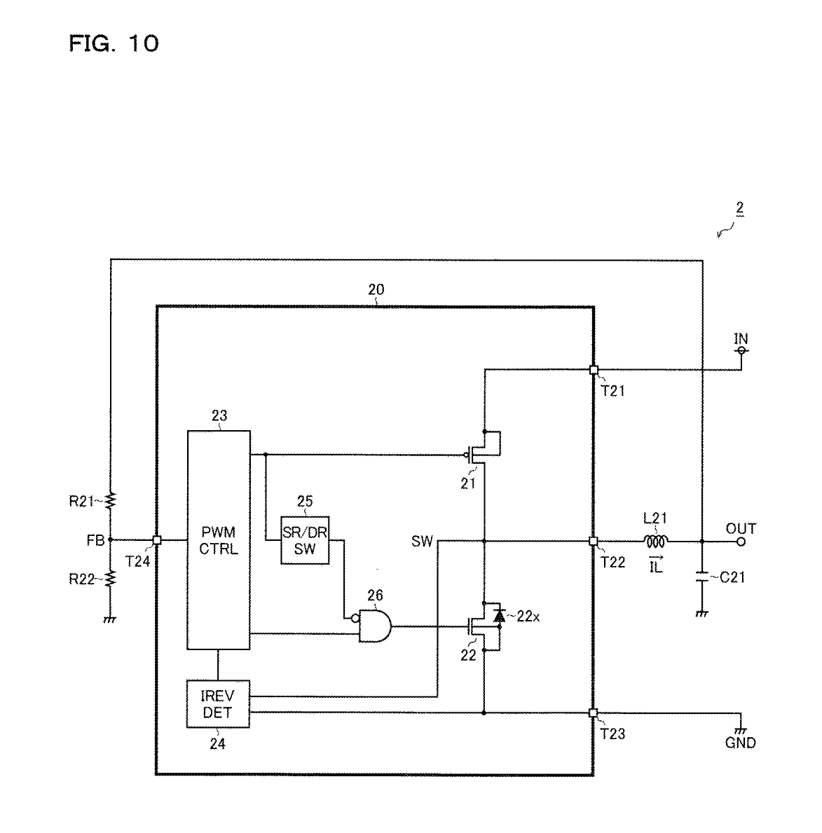

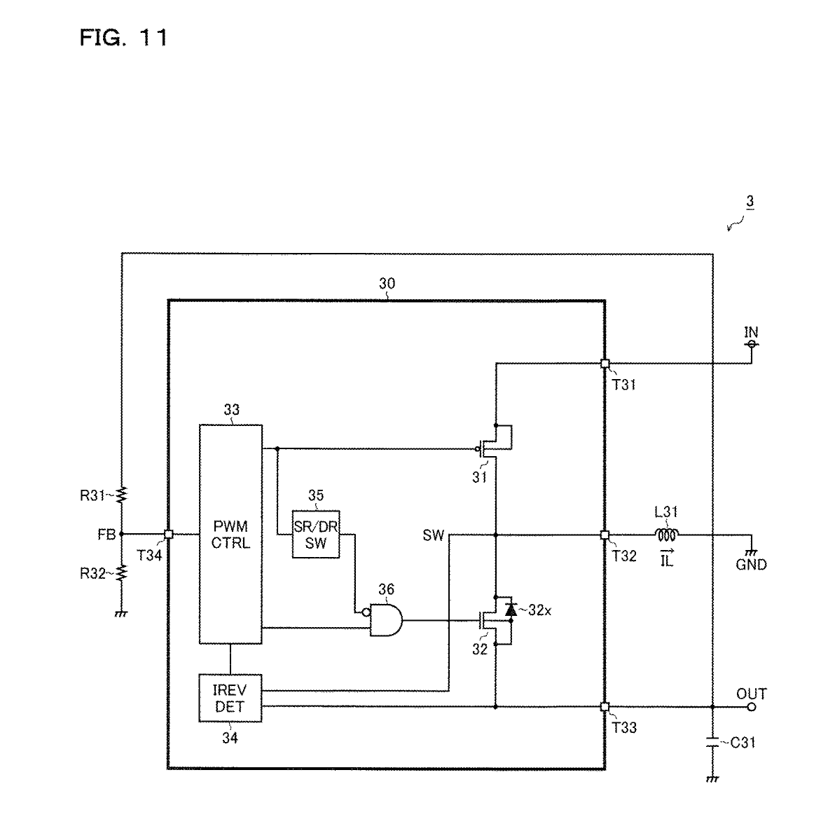

While the foregoing first to third embodiments have all been described by taking, as an example, the switching power source device 1 of the positive voltage step-up type (FIGS. 1, 7, and 8), without any limitation thereto, the present invention is broadly applicable also to a switching power source device 2 of the voltage step-down type (FIG. 10), a switching power source device 3 of the inverse type (negative voltage step-up type) (FIG. 11), and so on. Configurations of these modification examples, while slightly varying depending on their output types, are fundamentally similar to that of the foregoing positive voltage step-up type, and detailed descriptions thereof, therefore, are omitted.

Furthermore, in addition to the foregoing embodiments, various modifications of the various technical features disclosed in this specification are possible without departing from the spirit of the technical idea of the present invention. For example, it is arbitrary to use a bipolar transistor in place of a MOS field-effect transistor and vice versa and to invert a logic level of any of various signals. That is, the foregoing embodiments are to be construed in all respects as illustrative and not limiting. The technical scope of the present invention is indicated by the appended claims rather than by the foregoing descriptions of the embodiments, and it is to be understood that all changes that come within the meaning and range of equivalency of the claims are embraced therein.

### INDUSTRIAL APPLICABILITY

The present invention is applicable to all types of switching power source devices based on the synchronous rectification method.

### LIST OF REFERENCE NUMERALS

1, 2, 3 switching power source device (positive voltage step-up type, voltage step-down type, inverse type (negative voltage step-up type))
10, 20, 30 semiconductor device (switching power source IC)
11, 21, 31 output transistor
12, 22, 32 synchronous rectification transistor
12x, 22x, 32x body diode
13, 23, 33 control portion
14, 24, 34 countercurrent detection portion
15, 25, 35 rectification method changeover portion
16, 26, 36 logic gate
17 input blocking transistor
17x body diode
T11 to T14, T21 to T24, T31 to T34 external terminal
L11, L21, L31 inductor
C11, C21, C31 capacitor
R11, R12, R21, R22, R31, R32 resistor
SBD Schottky barrier diode
X portable terminal (smartphone)

What is claimed is:

1. A switching power source device, comprising:
a control portion that performs, at predetermined cycles, PWM pulse width modulation) driving with respect to an output transistor and a synchronous rectification transistor so that a desired output voltage is generated from an input voltage; and
a rectification method changeover portion that performs changeover of a rectification method so that, in one cycle, a synchronous rectification operation and a diode rectification operation are performed in a time-shared manner.

2. The switching power source device according to claim 1, wherein
the rectification method changeover portion adjusts a timing for performing the changeover of a rectification method.

3. The switching power source device according to claim 1, wherein
the rectification method changeover portion performs changeover between whether, in one cycle, to perform only the synchronous rectification operation or to perform the synchronous rectification operation and the diode rectification operation in a time-shared manner.

4. The switching power source device according to claim 1, wherein
the rectification method changeover portion performs changeover from the synchronous rectification operation to the diode rectification operation by forcibly turning off the synchronous rectification transistor in an on period of the synchronous rectification transistor, which is set by the control portion.

5. The switching power source device according to claim 4, wherein
the synchronous rectification transistor is accompanied by a body diode.

6. The switching power source device according to claim 4, wherein
a Schottky barrier diode is connected in parallel with the synchronous rectification transistor.

7. The switching power source device according to claim 1, wherein
the switching power source device has an output stage of a positive voltage step-up type, and
the switching power source device further comprises:
an input blocking transistor that connects/disconnects a supply path of the input voltage.

8. The switching power source device according to claim 1, further comprising:
a countercurrent detection portion that detects a countercurrent flowing to the synchronous rectification transistor and, upon the detection, generates a countercurrent detection signal,
wherein in accordance with the countercurrent detection signal, the control portion forcibly turns off the synchronous rectification transistor.

9. The switching power source device according to claim 1, wherein
the control portion is provided with a function of performing pulse skip control in which the output transistor and the synchronous rectification transistor are deliberately stopped from being driven over one cycle or a plurality of cycles.

10. An electronic apparatus comprising the switching power source device according to claim 1.

11. The switching power source device according to claim 2, wherein
the rectification method changeover portion performs changeover between whether, in one cycle, to perform only the synchronous rectification operation or to perform the synchronous rectification operation and the diode rectification operation in a time-shared manner.

12. The switching power source device according to claim 2, wherein
the rectification method changeover portion performs changeover from the synchronous rectification operation to the diode rectification operation by forcibly turning off the synchronous rectification transistor in an on period of the synchronous rectification transistor, which is set by the control portion.

13. The switching power source device according to claim 3, wherein
the rectification method changeover portion performs changeover from the synchronous rectification operation to the diode rectification operation by forcibly turning off the synchronous rectification transistor in an on period of the synchronous rectification transistor, which is set by the control portion.

14. The switching power source device according to claim 11, wherein
the rectification method changeover portion performs changeover from the synchronous rectification operation to the diode rectification operation by forcibly turning off the synchronous rectification transistor in an on period of the synchronous rectification transistor, which is set by the control portion.

15. The switching power source device according to claim 12, wherein
the synchronous rectification transistor is accompanied by a body diode.

16. The switching power source device according to claim 13, wherein
the synchronous rectification transistor is accompanied by a body diode.

17. The switching power source device according to claim 14, wherein
the synchronous rectification transistor is accompanied by a body diode.
